(19) United States
(12) Patent Application Publication
(10) Pub. No.: US 2007/0069986 A1
(43) Pub. Date: Mar. 29, 2007

(54) Plasma display apparatus and driving method thereof

(75) Inventor: Sangjin Yoon, Chilgok-gun (KR)

Correspondence Address: FLESHNER & KIM, LLP, P.O. BOX 221200, CHANTILLY, VA, 20153, US

(73) Assignee: LG Electronics Inc.

(21) Appl. No.: 11/515,795

(22) Filed: Sep. 6, 2006

(30) Foreign Application Priority Data
Sep. 28, 2005 (KR) 10-2005-0090849

(51) Int. Cl. G09G 3/28

(52) U.S. Cl. 345/63

(57) ABSTRACT

A plasma display apparatus is disclosed. The plasma display apparatus for displaying an image by processing image data input from the outside is selectively driven depending on whether the image data is an effective signal or an ineffective signal. Accordingly, reliability of the plasma display apparatus is improved.

This Nonprovisional application claims priority under 35 U.S.C. § 119(a) on Patent Application No. 2005-0090849 filed in Korea on Sep. 28, 2005 the entire contents of which are hereby incorporated by reference.

### BACKGROUND OF THE INVENTION

1. Field of the Invention

This document relates to a plasma display apparatus and a method of driving the plasma display apparatus.

2. Description of the Background Art

The plasma display panel comprises a front panel, a rear panel, and barrier ribs formed between the front panel and the rear panel. The barrier ribs form discharge cells. Each of the discharge cells is filled with an inert gas containing a main discharge gas such as neon (Ne), helium (He) or a Ne—He gas mixture and a small amount of xenon (Xe) When a high frequency voltage generates a discharge, the inert gas within the discharge cells generates vacuum ultraviolet rays. The vacuum ultraviolet rays emit a phosphor formed between the barrier ribs such that an image is displayed. Since the above-described plasma display panel can be manufactured to be thin and light, the plasma display panel has been considered as a next generation display apparatus.

FIG. 1 is a perspective view of a structure of a general plasma display panel.

As illustrated in FIG. 1, a plasma display panel comprises a front panel 100 and a rear panel 110 which are coupled in parallel to oppose to each other at a given distance therebetween.

A plurality of scan electrodes 102 and a plurality of sustain electrodes 103 are formed in pairs on a front substrate 101 of the front panel 110 being a display surface, on which an image is displayed, to form a plurality of maintenance electrode pairs. A plurality of address electrodes 113 are arranged on a rear substrate 111 of the rear panel 110 constituting a rear surface to intersect the plurality of maintenance electrode pairs.

The scan electrode 102 and the sustain electrode 103 each comprise transparent electrodes 102a and 103a made of a transparent indium-tin-oxide (ITO) material and bus electrodes 102b and 103b made of a metal material. The scan electrode 102 and the sustain electrode 103 generate a mutual discharge therebetween in one discharge cell and maintain emissions of the discharge cells. The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type (or well-type) barrier ribs 112 are formed in parallel on the rear substrate 111 of the rear panel 110 to form a plurality of discharge spaces, that is, a plurality of discharge cells. The plurality of address electrodes 113 for performing an address discharge and generating vacuum ultraviolet rays are arranged in parallel with the barrier ribs 112. Red (R), green (G) and blue (B) phosphors 114 are coated on an upper surface of the rear substrate 111 to emit visible light for displaying an image during the generation of the address discharge. A lower dielectric layer 115 for protecting the address electrodes 113 is formed between the address electrodes 113 and the phosphors 114.

The front panel 100 and the rear panel 110 are coalesced by a sealing process such that the plasma display panel is formed. A driver for driving the scan electrode 102, the sustain electrode 103 and the address electrode 113 is adhered to the plasma display panel such that a plasma display apparatus is completed.

The driver supplies a driving signal to each of the scan, sustain and address electrodes in response to image data input from the outside, and thus, the image of the plasma display apparatus is displayed.

When no image data is input from the outside, that is, an effective signal for an image display does not exist, various patterns are displayed on a screen of the plasma display panel. The screen pattern in such an ineffective signal state reduces a responsibility of the plasma display apparatus.

For example, since the driving signal is constantly supplied in the ineffective signal state, an afterimage worsens. Further, the number of switching operations in the plasma display apparatus increases depending on the screen pattern in the ineffective signal state. The increase in the number of switching operations causes the generation of heat of a driver integrated circuit (IC), thereby resulting in a serious damage of the driver IC.

Accordingly, the plasma display apparatus is stably driven and the responsibility thereof is reduced.

### SUMMARY OF THE INVENTION

Accordingly, an object of the present invention is to solve at least the problems and disadvantages of the related art.

According to an aspect, there is provided a plasma display apparatus comprising a plasma display panel on which an image is displayed by processing image data input from the outside, and an electrode driver for supplying a driving signal to an electrode of the plasma display panel in subfields of a frame, wherein the number of subfields in the frame when the image data is an effective signal is different from the number of subfields in the frame when the image data is an ineffective signal.

According to another aspect, there is provided a plasma display apparatus comprising a plasma display panel on which an image is displayed by processing image data input from the outside, and an electrode driver for supplying a sustain signal to an electrode of the plasma display panel in a frame, wherein the number of sustain signals in the frame when the image data is an effective signal is different from the number of sustain signals in the frame when the image data is an ineffective signal.

According to still another aspect, there is provided a plasma display apparatus comprising a plasma display panel on which an image is displayed by processing image data input from the outside, and an electrode driver for supplying a sustain signal to an electrode of the plasma display panel in a frame, wherein the width of the sustain signal when the image data is an effective signal is different from the width of the sustain signal when the image data is an ineffective signal.

### BRIEF DESCRIPTION OF THE DRAWINGS

The embodiment of the invention will be described in detail with reference to the following drawings in which like numerals refer to like elements.

FIG. 1 is a perspective view of a structure of a general plasma display panel;

FIG. 2 illustrates a plasma display apparatus according to a first embodiment of the present invention;

FIG. 3 illustrates an example of a method for representing gray scale of an image of the plasma display apparatus according to the first embodiment of the present invention;

FIG. 4 illustrates an example of a driving waveform of the plasma display apparatus according to the first embodiment of the present invention;

FIG. 5 illustrates an effect of the plasma display apparatus according to the first embodiment of the present invention;

FIG. 6 illustrates a plasma display apparatus according to a second embodiment of the present invention;

FIG. 7 illustrates a relationship between an average picture level (APL) and the number of sustain signals;

FIG. 8 illustrates an effect of the plasma display apparatus according to the second embodiment of the present invention;

FIG. 9 illustrates a plasma display apparatus according to a third embodiment of the present invention; and

FIG. 10 illustrates the control of a sustain signal in the plasma display apparatus according to the third embodiment of the present invention.

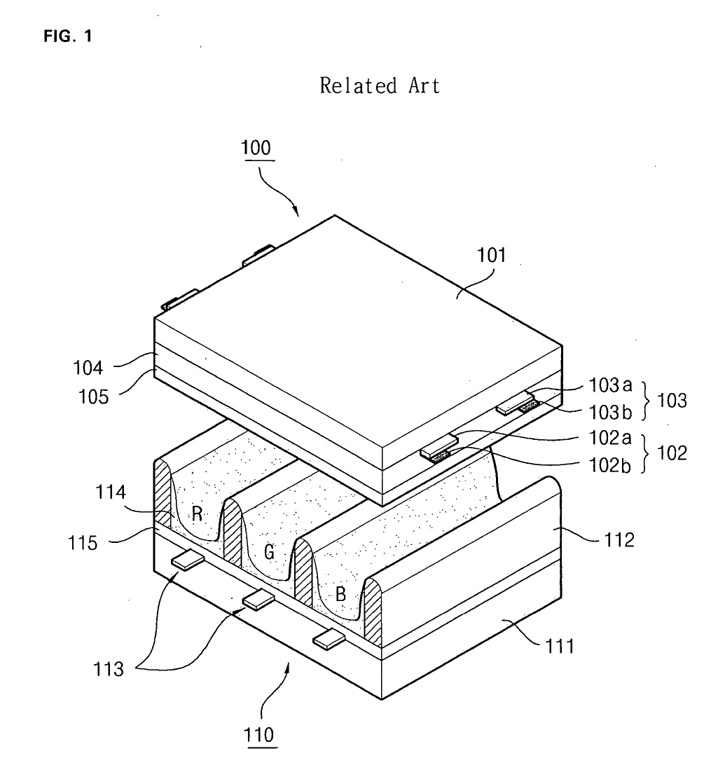

### DETAILED DESCRIPTION OF PREFERRED EMBODIMENTS

Preferred embodiments of the present invention will be described in a more detailed manner with reference to the attached drawings.

A plasma display apparatus according to embodiments of the present invention comprises a plasma display panel on which an image is displayed by processing image data input from the outside, and an electrode driver for supplying a driving signal to an electrode of the plasma display panel in subfields of a frame, wherein the number of subfields in the frame when the image data is an effective signal is different from the number of subfields in the frame when the image data is an ineffective signal.

The number of subfields of the frame when the image data is the ineffective signal may be less than the number of subfields of the frame when the image data is the effective signal.

When the subfields of the frame are arranged in ascending order of gray level weight, one or more subfield of the high gray level subfields, which follows a fourth subfield in the subfields, may decrease.

Two or more continuous subfields in the frame may decrease.

The duration of time of the frame when the image data is the effective signal may be substantially equal to the duration of time of the frame when the image data is the ineffective signal.

A plasma display apparatus according to the embodiments of the present invention comprises a plasma display panel on which an image is displayed by processing image data input from the outside, and an electrode driver for supplying a sustain signal to an electrode of the plasma display panel in a frame, wherein the number of sustain signals in the frame when the image data is an effective signal is different from the number of sustain signals in the frame when the image data is an ineffective signal.

The number of sustain signals of the frame when the image data is the ineffective signal may be less than the number of sustain signals of the frame when the image data is the effective signal.

When subfields of the frame are arranged in ascending order of gray level weight, the number of sustain signals in one or more subfield of the high gray level subfields, which follows a fourth subfield in the subfields, may decrease.

The number of sustain signals in the frame may equal to 200 or less.

A plasma display apparatus according to the embodiments of the present invention comprises a plasma display panel on which an image is displayed by processing image data input from the outside, and an electrode driver for supplying a sustain signal to an electrode of the plasma display panel in a frame, wherein the width of the sustain signal when the image data is an effective signal is different from the width of the sustain signal when the image data is an ineffective signal.

A rising time required to rise the sustain signal may be controlled.

The rising time of the sustain signal when the image data is the ineffective signal may be longer than the rising time of the sustain signal when the image data is the effective signal.

When subfields of the frame are arranged in ascending order of gray level weight, the rising time of the sustain signals in one or more subfield of the high gray level subfields, which follows a fourth subfield in the subfields, may decrease.

When the image data is the ineffective signal, the rising time of the sustain signal ranges from 450 ns to 650 ns.

Hereinafter, exemplary embodiments of the present invention will be described in detail with reference to the attached drawings.

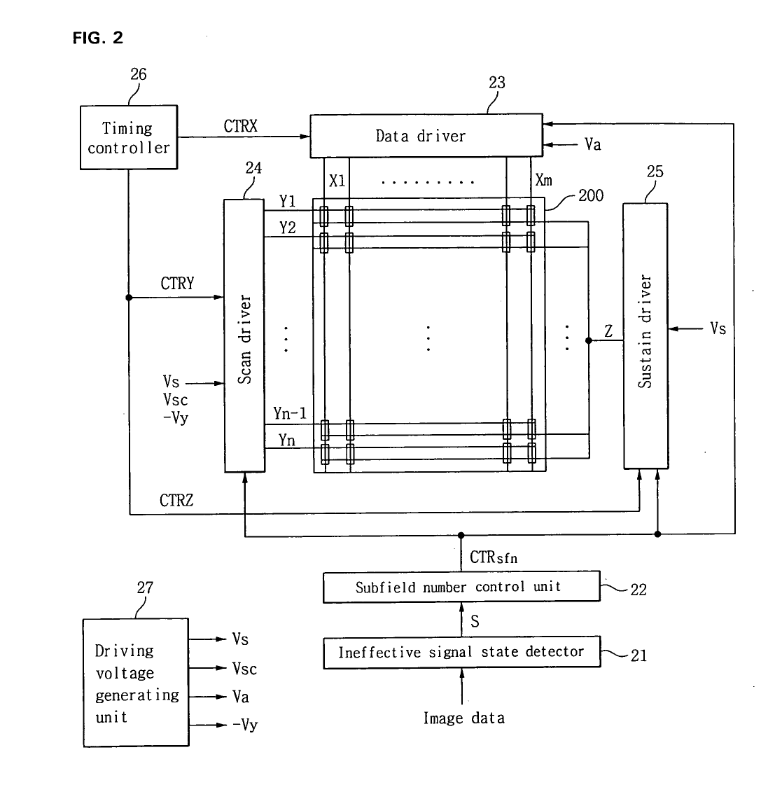

FIG. 2 illustrates a plasma display apparatus according to a first embodiment of the present invention.

As illustrated in FIG. 2, a plasma display apparatus according to a first embodiment of the present invention comprises a plasma display panel 200 on which an image is displayed by processing image data input from the outside, a data driver 23, a scan driver 24, a sustain driver 25, a timing controller 26 and a driving voltage generator 27. The data driver 23 supplies data to address electrodes X1 to Xm formed in the plasma display panel 200. The scan driver 24 drives scan electrodes Y1 to Yn. The sustain driver 25 drives sustain electrodes Z being common electrodes. The timing controller 26 controls the data driver 23, the scan driver 24 and the sustain driver 25. The driving voltage generator 27 supplies a necessary driving voltage to each of the drivers 23, 24 and 25.

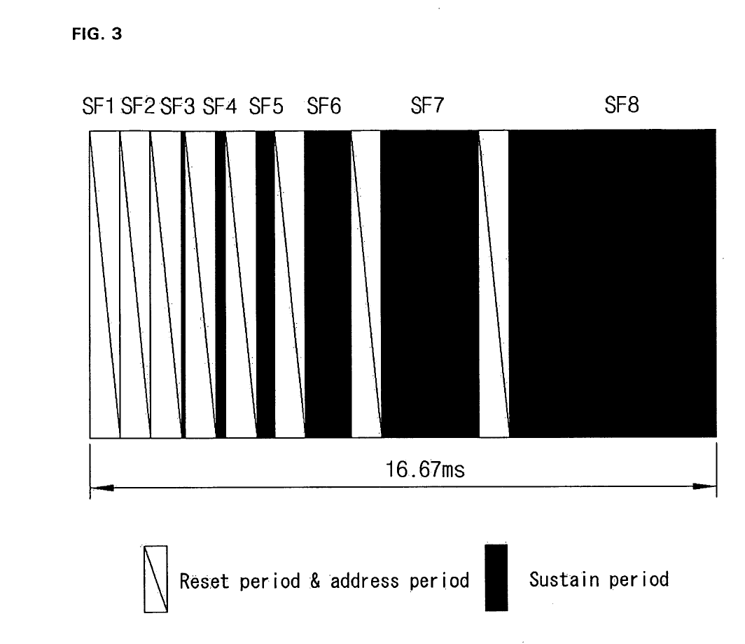

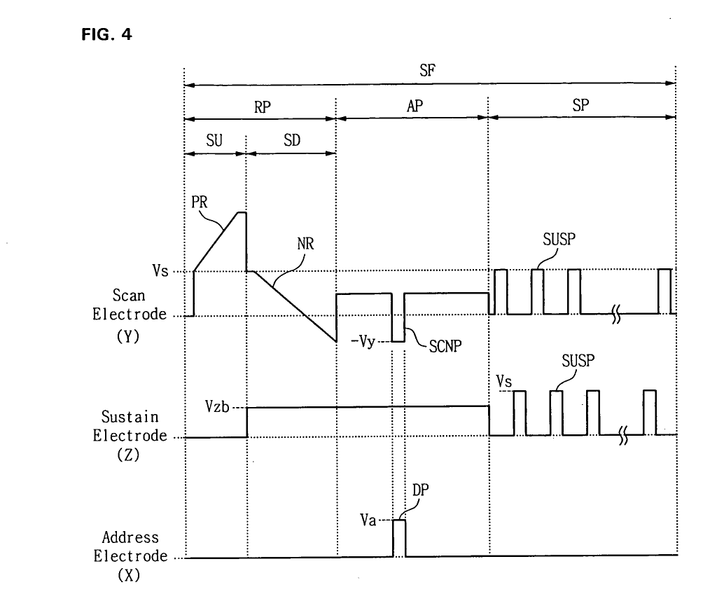

An example of a driving method of the plasma display apparatus will be described in detail with reference to FIGS. 3 and 4.

FIG. 3 illustrates an example of a method for representing gray scale of an image of the plasma display apparatus according to the first embodiment of the present invention.

As illustrated in FIG. 3, the plasma display apparatus is driven by dividing one frame in the plasma display panel into several subfields whose number of emissions are different from one another. Each of the subfields comprises a reset period for initializing all cells, an address period for selecting cells to be discharged, and a sustain period for representing gray scale depending on the number of discharges.

For example, in a case of representing 256-level gray scale, a frame period (16.67 ms) corresponding to 1/60 sec is divided into eight subfields SF1 to SF8. The eight subfields SF1 to SF8 each comprise a reset period, an address period, and a sustain period. The duration of the reset period in a subfield equals to the durations of the reset periods in the remaining subfields. The duration of the address period in a subfield equals to the durations of the address periods in the remaining subfields. The duration of the sustain period increases in a ratio of 2ⁿ (n=0, 1, 2, 3, 4, 5, 6, 7) in each of the subfields. As described above, since the duration of the sustain period changes in each of the subfields, gray scale is represented by controlling the sustain period of each of the subfields, that is, the number of sustain discharges.

An example of a driving waveform of the plasma display apparatus according to the first embodiment of the present invention is illustrated in FIG. 4.

FIG. 4 illustrates an example of a driving waveform of the plasma display apparatus according to the first embodiment of the present invention.

Referring to FIG. 4, the plasma display apparatus is driven by dividing one frame into each of subfields. Each of the subfields comprises a reset period RP for initializing all discharge cells on the whole screen, an address period AP for selecting discharge cells to be discharged, and a sustain period SP for discharge maintenance of the selected discharge cells.

In the reset period RP, a rising signal PR is simultaneously supplied to all of the scan electrodes Y during a setup period SU. The rising signal PR generates a weak dark discharge within the discharge cells of the whole screen such that wall charges are accumulated within the discharge cells. The weak dark discharge is called a setup discharge. In a set-down period SD, subsequent to the rising signal PR, a falling signal NR which falls from a positive sustain voltage Vs less than a peak voltage of the rising signal PR to a scan voltage −Vy of a negative polarity direction, is simultaneously supplied to the scan electrodes Y. The falling signal NR generates a weak erasure discharge within the discharge cells. The weak erase discharge sufficiently erases the wall charges and space charges excessively accumulated due to the generation of the setup discharge. By performing the weak erase discharge, the wall charges uniformly remain within the discharge cells to the degree that there is the generation of a stable address discharge.

In the address period AP, a scan signal SCNP of a negative polarity direction is sequentially supplied to the scan electrodes Y. At the same time, a data signal DP of a positive polarity direction synchronized with the scan signal SCNP is supplied to the address electrodes X. While a voltage difference between the scan signal SCNP and the data signal DP is added to the wall charges accumulated during the reset period RP, the address discharge is generated within the discharge cells to which the data signal DP is supplied. Wall charges are accumulated within the discharge cell selected by performing the address discharge.

A positive bias voltage Vzb is supplied to the sustain electrodes Z during the set-down period SD and the address period AP.

In the sustain period SP, a sustain signal SUSP is alternately supplied to the scan electrodes Y and the sustain electrodes Z. While the wall voltage within the cells selected by performing the address discharge is added to the sustain signal SUSP, a sustain discharge of a surface discharge type, that is, a display discharge, is generated between the scan electrodes Y and the sustain electrodes Z whenever the sustain signal SUSP is supplied.

The explanation was given of an example of the driving method of the plasma display apparatus. Below, a description of the plasma display apparatus of FIG. 2 succeeds.

The plasma display apparatus according to the first embodiment of the present invention further comprises a subfield number control unit 22.

A front substrate (not shown) and a rear substrate (not shown) of the plasma display panel 200 are coalesced with each other at a given distance therebetween. On the front substrate, a plurality of electrodes, for example, the scan electrodes Y1 to Yn and the sustain electrodes Z are formed in pairs. On the rear substrate, the address electrodes X1 to Xm are formed to intersect the scan electrodes Y1 to Yn and the sustain electrodes Z.

The data driver 23 receives data, which is inverse-gamma corrected and error-diffused by an inverse gamma correction circuit (not shown) and an error diffusion circuit (not shown) and then mapped in accordance to a subfield pattern pre-set by a subfield mapping circuit (not shown). The data driver 23 supplies the data, which is sampled and latched under the control of the timing controller 26, to the address electrodes X1 to Xm.

Under the control of the timing controller 26, the scan driver 24 supplies a reset signal comprising at least one of a rising signal with a gradually rising voltage and a falling signal with a gradually falling voltage to the scan electrodes Y1 to Yn during a reset period so that the whole screen is initialized.

Further, the scan driver 24 supplies a scan reference voltage Vsc and a scan signal, which falls from the scan reference voltage Vsc to a negative level voltage, to the scan electrodes Y1 to Yn during an address period which follows the reset period.

The scan driver 24 supplies a sustain signal to the scan electrodes Y1 to Yn during a sustain period so that a sustain discharge is generated within the cells selected in the address period.

Under the control of the timing controller 26, the sustain driver 25 supplies a bias voltage of a magnitude equal to a magnitude of the sustain voltage Vs to the sustain electrodes Z during at least a part of the reset period and the address period. Then, the sustain driver 25 supplies a sustain signal to the sustain electrodes Z during the sustain period. At this time, the scan driver 24 and the sustain driver 25 alternately operate.

The plasma display apparatus according to the first embodiment of the present invention further comprises the subfield number control unit 22, different from a related art plasma display apparatus.

The subfield number control unit 22 controls the number of subfields of one frame, depending on whether the image data input to the plasma display panel from the outside is effective or not.

An ineffective-signal-state detector 21 detects whether the image data is effective or not.

The ineffective-signal-state detector 21 receives the image data from the outside, and then detects whether or not the image data is in an ineffective signal state. Then, the ineffective-signal-state detector 21 supplies a judging signal S for judging whether or not the image data is in the ineffective signal state to the subfield number control unit 22.

The subfield number control unit 22 supplies a subfield number control signal CTRsfn to the data driver 23, the scan driver 24 and the sustain driver 25, depending on information on the judging signal S received from the ineffective-signal-state detector 21.

The data driver 23, the scan driver 24 and the sustain driver 25 are driven in response to the subfield controlled by the subfield number control signal CTRsfn received from the subfield number control unit 22.

For example, the subfield number control unit 22 decreases the number of subfields of one frame when the judging signal S received from the ineffective-signal-state detector 21 is in an ineffective signal state, in comparison to the number of subfields of one frame when the judging signal S is in an effective signal state. In other words, the number of subfields of one frame when the judging signal S is in the ineffective signal state is less than the number of subfields of one frame when the judging signal S is in the effective signal state.

When the number of subfields of one frame decreases, the number of switching operations in the plasma display apparatus decreases. The decrease in the number of subfields of one frame reduces the generation of heat in the driver IC and improves a driving characteristic of the plasma display apparatus.

Further, the decrease in the number of subfields of one frame reduces the number of sustain signals. Accordingly, the afterimage displayed on the screen is minimized, and the plasma display apparatus for displaying the high quality image is provided.

For example, the data signal may not be supplied so that the generation of heat of the driver IC is minimized by reducing the number of switching operations in the plasma display apparatus. In other words, the number of switching operations decreases by maintaining a voltage of the address electrode at a regular voltage in the address period. This efficiently solves a problem in the generation of heat in the driver IC.

A frame means a time unit for processing the image of the plasma display apparatus. The duration of time of a frame equals to the duration of time of another frame. As described above, by decreasing the number of subfields of one frame, optimum driving conditions of the plasma display apparatus is provided.

The timing controller 26 receives a vertical/horizontal synchronization signal. The timing controller 26 generates timing control signals CTRX, CTRY and CTRZ required in each of the drivers 23, 24 and 25. The timing controller 26 supplies the timing control signals CTRX, CTRY and CTRZ to each of the corresponding drivers 23, 24 and 25 to control the drivers 23, 24 and 25. The timing control signals CTRX supplied to the data driver 23 comprises a sampling clock for sampling data, a latch control signal, and a switch control signal for controlling on/off time of an energy recovery circuit and a driving switch element. The timing control signals CTRY supplied to the scan driver 24 comprises a switch control signal for controlling on/off time of an energy recovery circuit installed in the scan driver 24 and a driving switch element. The timing control signals CTRZ supplied to the sustain driver 25 comprises a switch control signal for controlling on/off time of an energy recovery circuit installed in the sustain driver 25 and a driving switch element.

The driving voltage generator 27 generates various driving voltages such as a sustain voltage Vs, a scan reference voltage Vsc, a data voltage Va, a scan voltage −Vy, required in each of the drivers 23, 24 and 25. The driving voltages may be changed depending on a composition of a discharge gas or a structure of the discharge cells.

The first embodiment of the present invention is not limited to the method for judging the ineffective signal state and the components such as the ineffective-signal-state detector 21, the subfield number control unit 22 required in the method. In other words, as long as the number of subfields in one frame is controlled depending on whether the image data is effective or not, it is included in the first embodiment of the present invention.

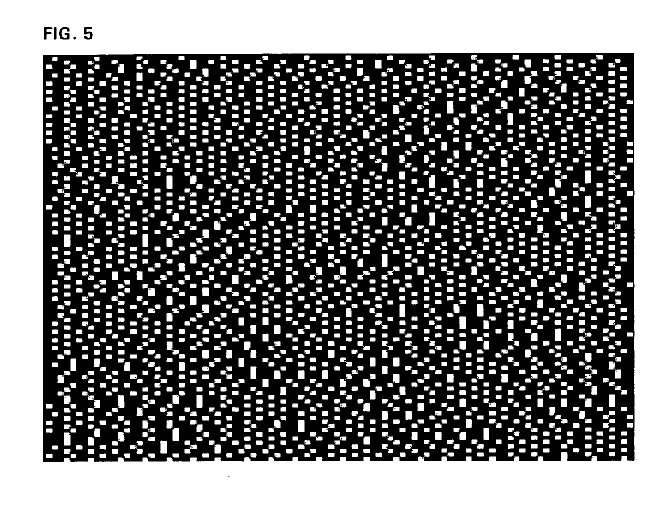

An effect obtained by reducing the number of subfields in the first embodiment of the present invention will be described in detail with reference to FIG. 5.

FIG. 5 illustrates an effect of the plasma display apparatus according to the first embodiment of the present invention.

FIG. 5 illustrates a screen pattern of a composite type ineffective signal state. As illustrated in FIG. 5, one pixel is turned on and a next pixel adjacent to one pixel is turned off in the ineffective signal state. A white noise is generated in such a screen pattern.

In particular, the number of switching operations in the plasma display apparatus increases in the screen pattern. However, in the first embodiment of the present invention, the number of switching operations in the plasma display apparatus can decrease by reducing the number of subfields. Accordingly, a driving stability of the plasma display apparatus is secured by decreasing the generation of heat of the data driver IC.

The subfield number control unit 22 reduces the number of subfields in one frame by reducing the number of high gray level subfields. For example, when the subfields of one frame are arranged in ascending order of gray level weight, the number of high gray level subfields, which follows a fourth subfield in the subfields, decreases.

As described above, the number of switching operation in the plasma display apparatus efficiently decreases by reducing the number of high gray level subfields. Further, since the ineffective signal state does not mean information on gray scale, the generation of heat in the data driver IC efficiently decreases by reducing the number of high gray level subfields.

Further, the subfield number control unit 22 may reduce two or more continuous subfields.

As described above, since the plasma display apparatus according to the first embodiment of the present invention controls the number of subfields depending on whether the image data is effective or not, the generation of heat in the data driver IC decreases and the plasma display apparatus is stably driven.

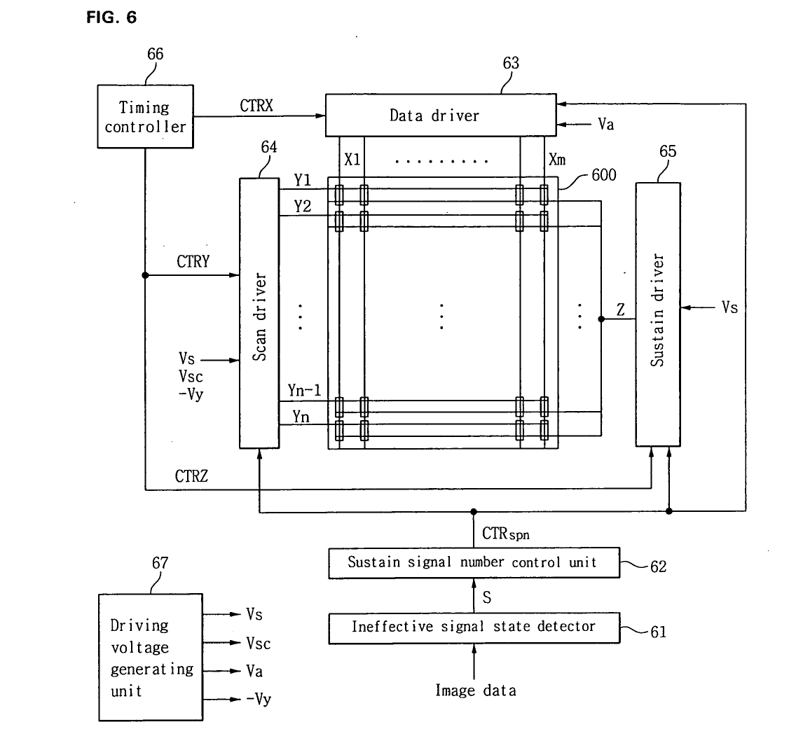

FIG. 6 illustrates a plasma display apparatus according to a second embodiment of the present invention.

As illustrated in FIG. 6, a plasma display apparatus according to a second embodiment of the present invention comprises a plasma display panel 600 on which an image is displayed by processing image data input from the outside, a data driver 63, a scan driver 64, a sustain driver 65, a timing controller 66 and a driving voltage generator 67. The data driver 63 supplies data to address electrodes X1 to Xm formed in the plasma display panel 600. The scan driver 64 drives scan electrodes Y1 to Yn. The sustain driver 65 drives sustain electrodes Z being common electrodes. The timing controller 66 controls each of the drivers 63, 64 and 65. The driving voltage generator 67 supplies a necessary driving voltage to each of the drivers 63, 64 and 65.

The scan driver 64 supplies a sustain signal to the scan electrodes Y1 to Yn during a sustain period so that a sustain discharge is generated within discharge cells selected in an address period. The number of sustain signals is controlled depending on information on the sustain signal received to a sustain signal number control unit 62.

The sustain driver 65 supplies a sustain signal to the sustain electrodes Z during the sustain period. At this time, the scan driver 64 and the sustain driver 65 alternately operate. The number of sustain signals is controlled depending on information on the sustain signal received to the sustain signal number control unit 62.

The description of components described in the second embodiment of FIG. 6 identical or equivalent to the components described in the first embodiment of FIG. 2 is briefly made or is entirely omitted. However, the equivalent component in the first and second embodiments does not have an equivalent structure and an equivalent function in the first and second embodiments.

The plasma display apparatus according to the second embodiment of the present invention further comprises the sustain signal number control unit 62, different from a related art plasma display apparatus.

The sustain signal number control unit 62 controls the number of sustain signals of one frame, depending on whether image data input to the plasma display panel from the outside is effective or not.

An ineffective-signal-state detector 61 detects whether the image data is effective or not.

The ineffective-signal-state detector 61 receives the image data input from the outside, and then detects whether or not the image data is in an ineffective signal state. Then, the ineffective-signal-state detector 61 supplies a judging signal S for judging whether or not the image data is in the ineffective signal state to the sustain signal number control unit 62.

The sustain signal number control unit 62 supplies a control signal CTRspn for controlling the number of sustain signals to the data driver 63, the scan driver 64 and the sustain driver 65, depending on information on the judging signal S received from the ineffective-signal-state detector 61.

The data driver 63, the scan driver 64 and the sustain driver 65 are driven in response to the control signal CTRspn received from the sustain signal number control unit 62.

For example, the sustain signal number control unit 62 decreases the number of sustain signals of one frame when the judging signal S received from the ineffective-signal-state detector 61 is in an ineffective signal state, in comparison to the number of sustain signals of one frame when the judging signal S is in an effective signal state. In other words, the number of sustain signals of one frame when the judging signal S is in the ineffective signal state is less than the number of sustain signals of one frame when the judging signal S is in the effective signal state.

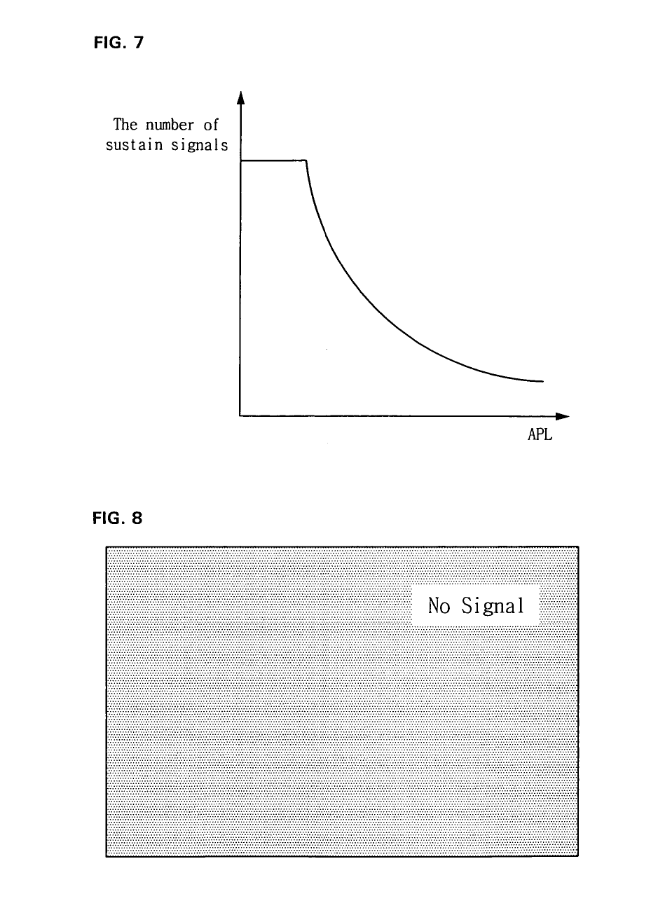

Since the number of sustain signals of one frame decreases in the ineffective signal state, a problem in an afterimage of the plasma display panel is solved. This will be described in detail with reference to FIGS. 7 and 8.

FIG. 7 illustrates a relationship between an average picture level (APL) and the number of sustain signals.

As illustrated in FIG. 7, when driving the plasma display panel, the number of sustain signals supplied during the sustain period is controlled in response to an APL. In other words, the number of sustain signals supplied in response to the APL is controlled in consideration of the sustain signal with a high level voltage, such that power consumption is minimized.

As illustrated in FIG. 7, the maximum number of sustain signals is supplied in the ineffective signal state, where no image data is input (APL=0), and at the low APL. On the other hand, as the APL increases, the number of sustain signals assigned per unit gray scale decreases. In other words, the APL is inversely proportional to the number of sustain signals.

For example, when the image is displayed on a portion with a relatively large area on the screen of the plasma display panel, the power consumption greatly increases. In other words, when the image is displayed on the portion with the relatively large area (at this time, the APL is a relatively high level), the number of discharge cells participating in the image display is relatively many. Therefore, by relatively decreasing the number of sustain signals per the unit gray scale supplied to each of the discharge cells participating in the image display, the whole power consumption of the plasma display panel decreases.

On the contrary, when the image is displayed on a portion with a relatively small area on the screen of the plasma display panel, the power consumption greatly decreases. In other words, when the image is displayed on the portion with the relatively small area (at this time, the APL is a relatively low level), the number of discharge cells participating in the image display is relatively few. Therefore, by relatively increasing the number of sustain signals per the unit gray scale supplied to each of the discharge cells participating in the image display, peak brightness increases and the image quality improves. The driving method considering the APL improves peak brightness being a drawback of the plasma display panel, such that the whole image quality improves and a rapid increase in the whole power consumption of the plasma display panel is prevented.

In the plasma display apparatus according to the second embodiment of the present invention, the maximum number of sustain signals is supplied in the ineffective signal state, that is, at the low APL. This will be described with reference to an ineffective signal state pattern illustrated in FIG. 8.

FIG. 8 illustrates an effect of the plasma display apparatus according to the second embodiment of the present invention.

FIG. 8 illustrates a screen pattern of a component type ineffective signal state. As illustrated in FIG. 8, a relatively large number of sustain signals are assigned in the ineffective signal state, that is, at the low APL.

Since the number of sustain signals increases in the screen pattern, the afterimage worsens. In the second embodiment of the present invention, the afterimage is minimized by decreasing the number of sustain signals. Accordingly, the quality image of the plasma display apparatus improves.

Since the image data does not exists in the ineffective signal state, the image is displayed by decreasing the brightness. Accordingly, the power consumption decreases and also the generation of heat of the driver IC decreases.

Further, since the sustain signal number control unit 62 decreases the number of sustain signals in the high gray level subfields, the number of sustain signals of one frame decreases. For example, when the subfields of one frame are arranged in ascending order of gray level weight, the number of sustain signals in the high gray level subfields, which follows a fourth subfield in the subfields, decreases.

As described above, since the number of sustain signals in the high gray level subfields decreases, the number of sustain signals more effectively decreases. In other words, since the number of sustain signals assigned in the high gray level subfields is more than the number of sustain signals assigned in the low gray level subfields, the afterimage effectively decreases.

At this time, the generation of the afterimage is minimized by setting the number of sustain signals in one frame to 200 or less.

As described above, since the plasma display apparatus according to the second embodiment of the present invention controls the number of sustain signals in one frame depending on whether the image data is effective or not, the afterimage improves and the plasma display apparatus with the high image quality is provided.

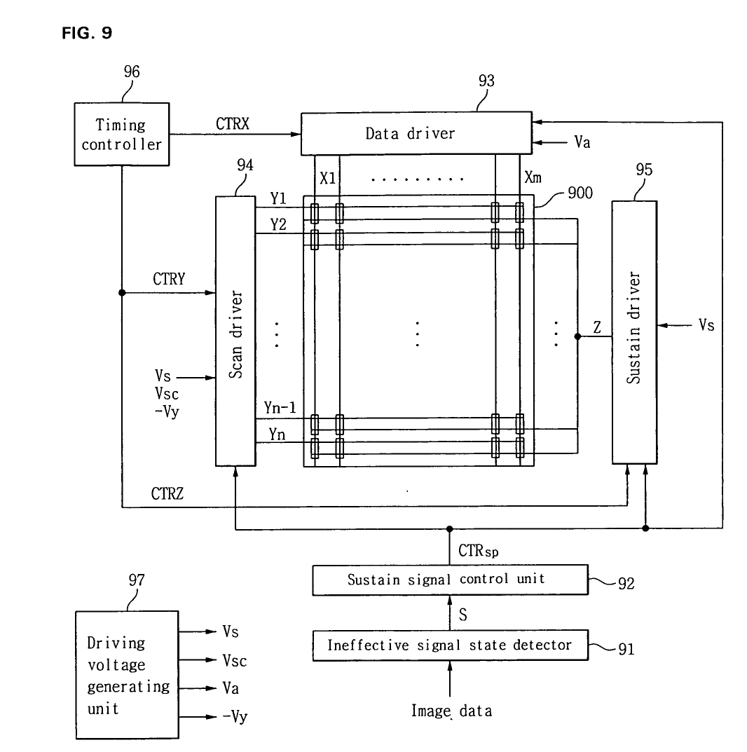

FIG. 9 illustrates a plasma display apparatus according to a third embodiment of the present invention.

As illustrated in FIG. 9, a plasma display apparatus according to a third embodiment of the present invention comprises a plasma display panel 900 on which an image is displayed by processing image data input from the outside, a data driver 93, a scan driver 94, a sustain driver 95, a timing controller 96 and a driving voltage generator 97. The data driver 93 supplies data to address electrodes X1 to Xm formed in the plasma display panel 900. The scan driver 94 drives scan electrodes Y1 to Yn. The sustain driver 95 drives sustain electrodes Z being common electrodes. The timing controller 96 controls each of the drivers 93, 94 and 95. The driving voltage generator 97 supplies a necessary driving voltage to each of the drivers 93, 94 and 95.

The scan driver 94 supplies a sustain signal to the scan electrodes Y1 to Yn during a sustain period so that a sustain discharge is generated within discharge cells selected in an address period. The sustain signal is controlled depending on information on the sustain signal received to a sustain signal control unit 92.

The sustain driver 95 supplies a sustain signal to the sustain electrodes Z during the sustain period. At this time, the scan driver 94 and the sustain driver 95 alternately operate. The sustain signal is controlled depending on information on the sustain signal received to the sustain signal control unit 92.

The description of components described in the third embodiment of FIG. 9 identical or equivalent to the components described in the first embodiment of FIG. 2 is briefly made or is entirely omitted. However, the equivalent component in the first and third embodiments does not have an equivalent structure and an equivalent function in the first and third embodiments.

The plasma display apparatus according to the third embodiment of the present invention further comprises the sustain signal control unit 92, different from a related art plasma display apparatus.

The sustain signal control unit 92 controls the sustain signal of one frame, depending on whether image data input to the plasma display panel from the outside is effective or not.

An ineffective-signal-state detector 91 detects whether the image data is effective or not.

The ineffective-signal-state detector 91 receives the image data from the outside, and then detects whether or not the image data is in an ineffective signal state. Then, the ineffective-signal-state detector 91 supplies a judging signal S for judging whether or not the image data is in the ineffective signal state to the sustain signal control unit 92.

The sustain signal control unit 92 supplies a sustain control signal CTRsp to the data driver 93, the scan driver 94 and the sustain driver 95, depending on information on the judging signal S received from the ineffective-signal-state detector 91.

The data driver 93, the scan driver 94 and the sustain driver 95 are driven in response to the control signal CTRsp received from the sustain signal control unit 92.

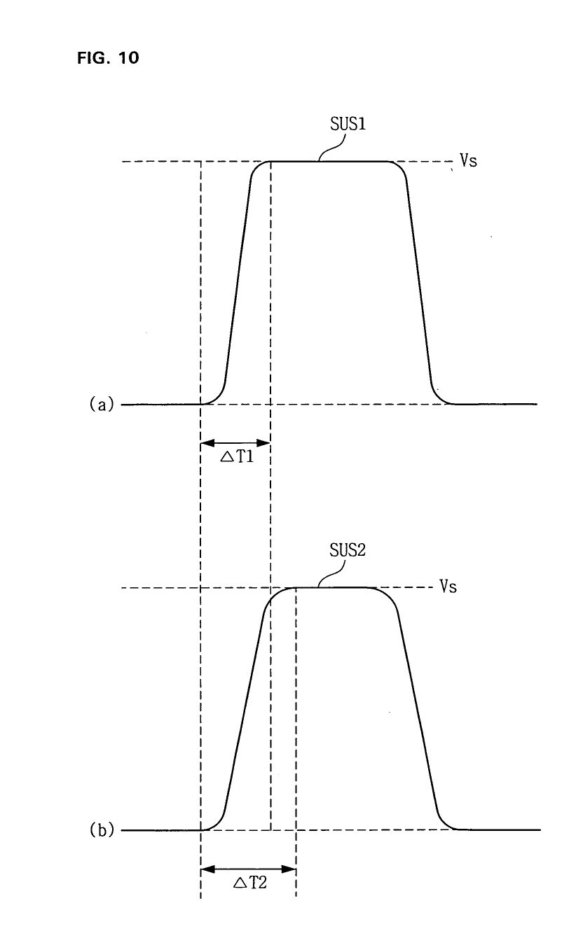

The sustain signal control unit 92 controls a rising time of the sustain signal. For example, the sustain signal control unit 92 increases the rising time of the sustain signal when the judging signal S received from the ineffective-signal-state detector 91 is in an ineffective signal state, in comparison to the rising time of the sustain signal when the judging signal S is in an effective signal state. In other words, the rising time of the sustain signal when the judging signal S is in the ineffective signal state is longer than the rising time of the sustain signal when the judging signal S is in the effective signal state. The control of the rising time of the sustain signal is illustrated in FIG. 10.

FIG. 10 illustrates the control of a sustain signal in the plasma display apparatus according to the third embodiment of the present invention.

(a) of FIG. 10 illustrates a sustain signal SUS1 when the image data is in the effective signal state. (b) of FIG. 10 illustrates a sustain signal SUS2 when the image data is in the ineffective signal state.

As illustrated in FIG. 10, the rising time AT2 of the sustain signal SUS2 supplied in the ineffective signal state is longer than the rising time ΔT1 of the sustain signal SUS1 supplied in the effective signal state. For example, a problem in an afterimage is solved by controlling the rising time ΔT2 of the sustain signal SUS2 in the range of 450 ns to 650 ns.

The afterimage caused by the sustain signal in the screen pattern of the component type ineffective signal state of FIG. 8 is minimized. Accordingly, the image quality improves and the generation of the unnecessary brightness is prevented.

In the third embodiment of the present invention, the sustain signal in the high gray level subfield is controlled. For example, when the subfields of one frame are arranged in ascending order of gray level weight, the rising time of the sustain signals in the high gray level subfields, which follows a fourth subfield in the subfields, increases.

As described above, since the sustain signals is controlled in the high gray level subfields, the afterimage more efficiently decreases.

As described above, since the plasma display apparatus according to the third embodiment of the present invention controls the sustain signals depending on whether the image data is effective or not, a problem in the afterimage is solved and the plasma display apparatus with the high image quality is provided.

In the third embodiment of the present invention, the control of the width of the sustain signal means the control from the supply start time point to the supply end point of the sustain signal. In other words, the control of the width of the sustain signal comprises the control of the rising time, the maintenance time, and the falling time of the sustain signal. Therefore, the third embodiment for controlling the sustain signal is not limited to the control of the rising time of the sustain signal. In other words, the rising time, the falling time, the maintenance time of the sustain signal, and the like, may be controlled.

The embodiments of the present invention are not limited to the above described components. As long as the number of subfields, the number of sustain signals and the conditions of the sustain signal in one frame are controlled depending on whether the image data input from the outside is effective or not, it is included in the embodiments of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel on which an image is displayed by processing image data input from the outside; and
an electrode driver for supplying a driving signal to an electrode of the plasma display panel in subfields of a frame,
wherein the number of subfields in the frame when the image data is an effective signal is different from the number of subfields in the frame when the image data is an ineffective signal.

2. The plasma display apparatus of claim 1, wherein the number of subfields of the frame when the image data is the ineffective signal is less than the number of subfields of the frame when the image data is the effective signal.

3. The plasma display apparatus of claim 2, wherein when the subfields of the frame are arranged in ascending order of gray level weight, one or more subfield of the high gray level subfields, which follows a fourth subfield in the subfields, decreases.

4. The plasma display apparatus of claim 2, wherein two or more continuous subfields in the frame decrease.

5. The plasma display apparatus of claim 1, wherein the duration of time of the frame when the image data is the effective signal is substantially equal to the duration of time of the frame when the image data is the ineffective signal.

6. A plasma display apparatus comprising:
a plasma display panel on which an image is displayed by processing image data input from the outside; and
an electrode driver for supplying a sustain signal to an electrode of the plasma display panel in a frame,
wherein the number of sustain signals in the frame when the image data is an effective signal is different from the number of sustain signals in the frame when the image data is an ineffective signal.

7. The plasma display apparatus of claim 6, wherein the number of sustain signals of the frame when the image data is the ineffective signal is less than the number of sustain signals of the frame when the image data is the effective signal.

8. The plasma display apparatus of claim 7, wherein when subfields of the frame are arranged in ascending order of gray level weight, the number of sustain signals in one or more subfield of the high gray level subfields, which follows a fourth subfield in the subfields, decreases.

9. The plasma display apparatus of claim 7, wherein the number of sustain signals in the frame equals to 200 or less.

10. A plasma display apparatus comprising:
a plasma display panel on which an image is displayed by processing image data input from the outside; and
an electrode driver for supplying a sustain signal to an electrode of the plasma display panel in a frame,
wherein the width of the sustain signal when the image data is an effective signal is different from the width of the sustain signal when the image data is an ineffective signal.

11. The plasma display apparatus of claim 10, wherein a rising time required to rise the sustain signal is controlled.

12. The plasma display apparatus of claim 10, wherein the rising time of the sustain signal when the image data is the ineffective signal is longer than the rising time of the sustain signal when the image data is the effective signal.

13. The plasma display apparatus of claim 12, wherein when subfields of the frame are arranged in ascending order of gray level weight, the rising time of the sustain signals in one or more subfield of the high gray level subfields, which follows a fourth subfield in the subfields, decreases.

14. The plasma display apparatus of claim 12, wherein when the image data is the ineffective signal, the rising time of the sustain signal ranges from 450 ns to 650 ns.
